(19) United States
(12) Patent Application Publication
(10) Pub. No.: US 2015/0078162 A1
(43) Pub. Date: Mar. 19, 2015

(54) BACKHAUL SELECTION FOR WIRELESS COMMUNICATION

(71) Applicant: QUALCOMM Incorporated, San Diego, CA (US)

(72) Inventors: Rajat PRAKASH, San Diego, CA (US); Christophe CHEVALLIER, San Diego, CA (US)

(73) Assignee: QUALCOMM Incorporated, San Diego, CA (US)

(21) Appl. No.: 14/028,314

(22) Filed: Sep. 16, 2013

(51) Int. Cl. H04W 28/02; H04W 28/10

(52) U.S. Cl. CPC H04W 28/0268; H04W 28/10
USPC 370/235

(57) ABSTRACT

Different types of backhauls are used to provide connectivity for an access point. In some implementations, an access point monitors conditions on at least one backhaul to determine whether each backhaul is capable of supporting any QoS requirements of the access point's traffic flows. If the access point determines that a backhaul is capable of supporting the QoS requirement of a given traffic flow, the access point may configure the traffic flow to be routed via that backhaul. In some implementations, an access point selects a different backhaul for a traffic flow based on the type of traffic flow. For example, upon determining that a traffic flow is destined for an entity associated with another backhaul, the access point may switch to the other backhaul for routing that traffic flow.

### BACKGROUND

1. Field

This application relates generally to wireless communication and more specifically, but not exclusively, to backhaul selection.

2. Introduction

A wireless communication network may be deployed to provide various types of services (e.g., voice, data, multimedia services, etc.) to users within a geographical area. In a typical implementation, macro access points (e.g., corresponding to different macro cells) are distributed throughout a network to provide wireless connectivity for access terminals (e.g., cell phones) that are operating within the geographical area served by the network. Core network entities support connectivity between access points, access to other networks (e.g., the Internet), management functions, and other related functions.

In some networks, low-power access points (e.g., femto cells) are deployed to supplement conventional network access points (e.g., macro access points). For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.). In general, these low-power access points provide more robust coverage and higher throughput for access terminals in the vicinity of the low-power access points.

Access points for a wireless network typically connect to the core network or Internet via a backhaul connection. In general, relatively high bandwidth backhauls are provided for macro access points. In contrast, low-power access points typically connect to the Internet via a wired subscriber-centric connection (e.g., a digital subscriber line (DSL) router, a cable modem, or some other type of modem) that provides a backhaul link to a mobile operator's network.

In practice, traffic routed over a backhaul to and from an access point may have different quality of service (QoS) requirements. For example, traffic flow for an access point may be latency critical (e.g., voice traffic or signaling traffic) or non-critical (e.g., file transfer traffic). However, the backhaul for a given access point may not always be able to meet the QoS requirements of the traffic handled by that access point. In particular, the backhaul for a low-power access point may be a wired connection with a varying delay. In some cases, delay variations are due to other nodes sharing the same wired connection. For example, several Internet users in neighboring apartments can share a cable backhaul. In some cases, delay variations are due to buffering delays within the access point. For example, if file transfer packets are already in the transmit buffer waiting to be transmitted, service of latency sensitive traffic subsequently added to the transmit buffer may be delayed. Variations in delay may be addressed through the use of a guaranteed quality of service (QoS) implementation; however, a guaranteed QoS implementation is not always available.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to using different types of backhauls to provide Internet and/or core network connectivity for an access point. One of these backhauls is the default backhaul for the access point. Typically, the default backhaul is a wired backhaul (e.g., cable or fiber), although it may be wireless (e.g., a microwave backhaul) in some cases. The other backhaul is a wireless backhaul that provides more predictable (e.g., guaranteed) QoS than the default backhaul. For example, the other backhaul may provide connectively via a wireless wide area network (W-WAN).

In some implementations, an access point monitors conditions on the default backhaul to determine whether the default backhaul is capable of supporting any QoS requirements of the access point's traffic flows. For example, the access point may monitor at least one of: traffic queue delays, traffic round trip times, or traffic throughput on the default backhaul.

If the access point determines that the default backhaul is capable of supporting the QoS requirements of a given traffic flow, the access point configures that traffic flow to be routed via the default backhaul. Conversely, if the default backhaul is not capable of supporting the QoS requirements of that traffic flow, the access point configures the traffic flow to be routed via the other backhaul.

The selection of a backhaul for a given traffic flow also may involve monitoring conditions on the other backhaul to determine whether the other backhaul is capable of supporting the QoS requirements of the traffic flow. For example, the access point may monitor received signal strength and/or loading on the W-WAN to determine whether to route a traffic flow via the W-WAN backhaul.

In some implementations, an access point selects a different backhaul for a traffic flow based on the type of traffic flow. For example, upon determining that a traffic flow is destined for an entity associated with another backhaul, the access point may switch to the other backhaul for routing of that traffic flow.

The teachings herein may be embodied and/or practiced in different ways in different embodiments.

In some aspects, an apparatus for communication in accordance with the teachings herein comprises: a processing system configured to determine whether a default wired backhaul provides sufficient quality of service for a traffic flow, and further configured to select between the default wired backhaul and a wireless backhaul for routing of the traffic flow, wherein the selection between the default wired backhaul and the wireless backhaul is based on the determination of whether the default wired backhaul provides sufficient quality of service; and a communication device configured to route the traffic flow via the selected backhaul.

In some aspects, a method of communication in accordance with the teachings herein comprises: determining whether a default wired backhaul provides sufficient quality of service for a traffic flow; selecting between the default wired backhaul and a wireless backhaul for routing of the traffic flow, wherein the selection between the default wired backhaul and the wireless backhaul is based on the determination of whether the default wired backhaul provides sufficient quality of service; and routing the traffic flow via the selected backhaul.

In some aspects, an apparatus for communication in accordance with the teachings herein comprises: means for determining whether a default wired backhaul provides sufficient quality of service for a traffic flow; means for selecting between the default wired backhaul and a wireless backhaul for routing of the traffic flow, wherein the selection between the default wired backhaul and the wireless backhaul is based on the determination of whether the default wired backhaul provides sufficient quality of service; and means for routing the traffic flow via the selected backhaul.

In some aspects, a computer-program product in accordance with the teachings herein comprises computer-readable medium comprising code for causing a computer to: determine whether a default wired backhaul provides sufficient quality of service for a traffic flow; select between the default wired backhaul and a wireless backhaul for routing of the traffic flow, wherein the selection between the default wired backhaul and the wireless backhaul is based on the determination of whether the default wired backhaul provides sufficient quality of service; and route the traffic flow via the selected backhaul.

In some aspects, an apparatus for communication in accordance with the teachings herein comprises: a communication device configured to route a first traffic flow via a default backhaul; and a processing system configured to determine that a second traffic flow is directed to a destination associated with another backhaul, wherein the communication device is further configured to route the second traffic flow via the other backhaul as a result of the determination that the second traffic flow is directed to the destination associated with the other backhaul.

In some aspects, a method of communication in accordance with the teachings herein comprises: routing a first traffic flow via a default backhaul; determining that a second traffic flow is directed to a destination associated with another backhaul; and routing the second traffic flow via the other backhaul as a result of the determination that the second traffic flow is directed to the destination associated with the other backhaul.

In some aspects, an apparatus for communication in accordance with the teachings herein comprises: means for routing a first traffic flow via a default backhaul; means for determining that a second traffic flow is directed to a destination associated with another backhaul; and means for routing the second traffic flow via the other backhaul as a result of the determination that the second traffic flow is directed to the destination associated with the other backhaul.

In some aspects, a computer-program product in accordance with the teachings herein comprises computer-readable medium comprising code for causing a computer to: route a first traffic flow via a default backhaul; determine that a second traffic flow is directed to a destination associated with another backhaul; and route the second traffic flow via the other backhaul as a result of the determination that the second traffic flow is directed to the destination associated with the other backhaul.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of several sample aspects of a communication system adapted to support backhaul selection in accordance with the teachings herein;

FIG. 2 is a flowchart of several sample aspects of operations that may be performed in conjunction with switching between backhauls;

FIG. 3 is a flowchart of several sample aspects of operations that may be performed in conjunction with selecting a backhaul for routing a traffic flow;

FIG. 4 is a flowchart of several sample aspects of operations that may be performed in conjunction with selecting a backhaul based on predictability of quality of service associated with different backhauls;

FIG. 5 is a flowchart of several sample aspects of operations that may be performed in conjunction with routing traffic over a backhaul according to a destination of a traffic flow;

FIG. 6 is a simplified block diagram of several sample aspects of components that may be employed in communication nodes;

FIG. 7 is a simplified diagram of a wireless communication system;

FIG. 8 is a simplified diagram of a wireless communication system including small cells;

FIG. 9 is a simplified diagram illustrating coverage areas for wireless communication;

FIG. 10 is a simplified block diagram of several sample aspects of communication components; and

FIGS. 11 and 12 are simplified block diagrams of several sample aspects of apparatuses configured to support backhaul selection as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, any aspect disclosed herein may be embodied by one or more elements of a claim.

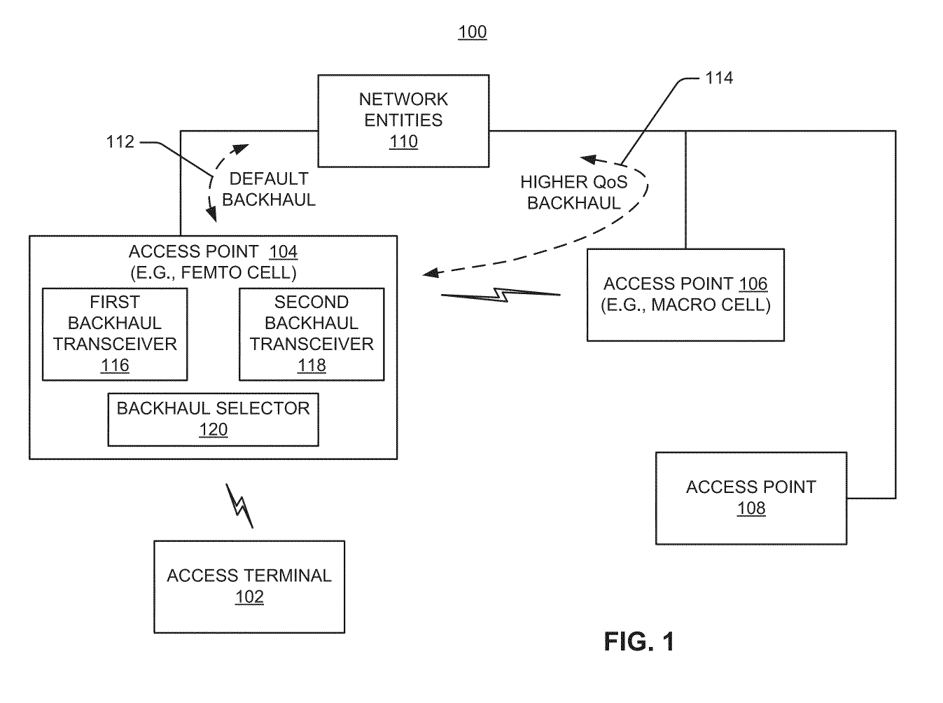

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, small cells, macro cells, femto cells, and so on, while access terminals may be referred to or implemented as user equipment (UEs), mobile stations, and so on.

Access points in the system 100 provide access to one or more services (e.g., network connectivity) for one or more wireless terminals (e.g., access terminal 102) that may be installed within or that may roam throughout a coverage area of the system 100. For example, at various points in time the access terminal 102 may connect to an access point 104, an access point 106, an access point 108, or some other access point in the system 100 (not shown).

Each of the access points may communicate with one or more network entities (represented, for convenience, by network entities 110), including each other, to facilitate wide area network connectivity. Two or more of such network entities may be co-located and/or two or more of such network entities may be distributed throughout a network.

A network entity may take various forms such as, for example, one or more radio and/or core network entities. Thus, in various implementations the network entities 110 may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals.

Some of the access points (e.g., the access point 104) in the system 100 may comprise low-power access points. Various types of low-power access points may be employed in a given system. For example, low-power access points may be implemented as or referred to as femto cells, femto access points, small cells, femto nodes, home NodeBs (HNBs), home eNodeBs (HeNBs), access point base stations, pico cells, pico nodes, or micro cells.

As used herein, the term low-power access point refers to an access point having a transmit power (e.g., one or more of: maximum transmit power, instantaneous transmit power, nominal transmit power, average transmit power, or some other form of transmit power) that is less than a transmit power (e.g., as defined above) of any macro access point in the coverage area. In some implementations, each low-power access point has a transmit power (e.g., as defined above) that is less than a transmit power (e.g., as defined above) of the macro access point by a relative margin (e.g., 10 dBm or more). In some implementations, low-power access points such as femto cells may have a maximum transmit power of 20 dBm or less. In some implementations, low-power access points such as pico cells may have a maximum transmit power of 24 dBm or less. It should be appreciated, however, that these or other types of low-power access points may have a higher or lower maximum transmit power in other implementations (e.g., up to 1 Watt in some cases, up to 10 Watts in some cases, and so on).

For convenience, low-power access points may be referred to simply as small cells in the discussion that follows. Thus, it should be appreciated that any discussion related to small cells herein may be equally applicable to low-power access points in general (e.g., to femto cells, to micro cells, to pico cells, etc.).

Small cells may be configured to support different types of access modes. For example, in an open access mode, a small cell may allow any access terminal to obtain any type of service via the small cell. In a restricted (or closed) access mode, a small cell may only allow authorized access terminals to obtain service via the small cell. For example, a small cell may only allow access terminals (e.g., so called home access terminals) belonging to a certain subscriber group (e.g., a closed subscriber group (CSG)) to obtain service via the small cell. In a hybrid access mode, alien access terminals (e.g., non-home access terminals, non-CSG access terminals) may be given limited access to the small cell. For example, a macro access terminal that does not belong to a small cell's CSG may be allowed to access the small cell only if sufficient resources are available for all home access terminals currently being served by the small cell.

Thus, small cells operating in one or more of these access modes may be used to provide indoor coverage and/or extended outdoor coverage. By allowing access to users through adoption of a desired access mode of operation, small cells may provide improved service within the coverage area and potentially extend the service coverage area for users of a macro network.

The disclosure relates in some aspects to using multiple backhauls for routing traffic. A decision on which backhaul to use may be based on, for example, the capabilities of the backhauls, the conditions on the backhauls, or the type of traffic. As used herein, the term backhaul refers to a communication link that connects an access point to a network. For example, a backhaul may connect an access point to a core network and/or the Internet.

The access point 104 of FIG. 1 employs two backhauls: a default backhaul 112 and a higher QoS backhaul 114. In the example of FIG. 1, the default backhaul 112 is shown as being a wired backhaul and the higher QoS backhaul 114 is shown as being a wireless backhaul. It should be appreciated, however, that different backhaul technologies and a different number of backhauls (i.e., three or more) may be employed in different implementations.

A wireless backhaul typically provides a connection to a wide area network (WAN) via an access point (e.g., a macro cell such as an eNB). Examples of wireless-WANs (W-WANs) include a UMTS network, an LTE network, a WiMAX network, and so on. Advantageously, such a backhaul may more effectively transport QoS (e.g., latency) critical traffic. For example, a wireless backhaul can have lower latency than a wired backhaul because QoS is more likely to be implemented in the W-WAN, and because the W-WAN is less likely to be subject to unpredictable loading, in contrast with a shared wired backhaul.

The access point 104 includes several components to facilitate the use of multiple backhauls. The access point 104 employs a first backhaul transceiver 116 (e.g., a transceiver that communicates via a wired connection) for communicating via the default backhaul 112. The access point 104 also employs a second backhaul transceiver 118 (e.g., a transceiver that communicates via a wireless connection) for communicating via the higher QoS backhaul 114. In addition, the access point 104 employs a backhaul selector 120 for selecting one of the backhauls for routing traffic.

The backhaul selector 120 may select the backhaul to use based on one or more criteria. In some aspects, the backhaul selection may be made on a continual basis (e.g., QoS on a backhaul is repeatedly monitored over time to determine whether to switch the current traffic to another backhaul). In some aspects, the backhaul selection may be made on a per traffic flow basis (e.g., a backhaul selection is made for each traffic flow), or on some other basis (e.g., all traffic could be routed over a given backhaul in some cases).

In some implementations, backhaul selection decisions are based on QoS (e.g., latency, loading, etc.) estimates for one or more of the backhauls. For example, traffic may be switched from the default backhaul 112 to the higher QoS backhaul 114 whenever the default backhaul 112 cannot meet the QoS requirements of the traffic.

The manner in which a backhaul is selected is also implementation dependent. In some implementations, the access point makes autonomous decisions regarding whether to switch backhauls. In other implementations, there could be negotiation between the access point and the W-WAN to determine which traffic is routed on which backhaul.

In some implementations, backhaul selection decisions are based on other characteristics of the traffic. For example, the traffic routing algorithm may prefer the wireless backhaul for traffic directly destined to the WAN (e.g., X2 signaling packets between the access point and a W-WAN eNB).

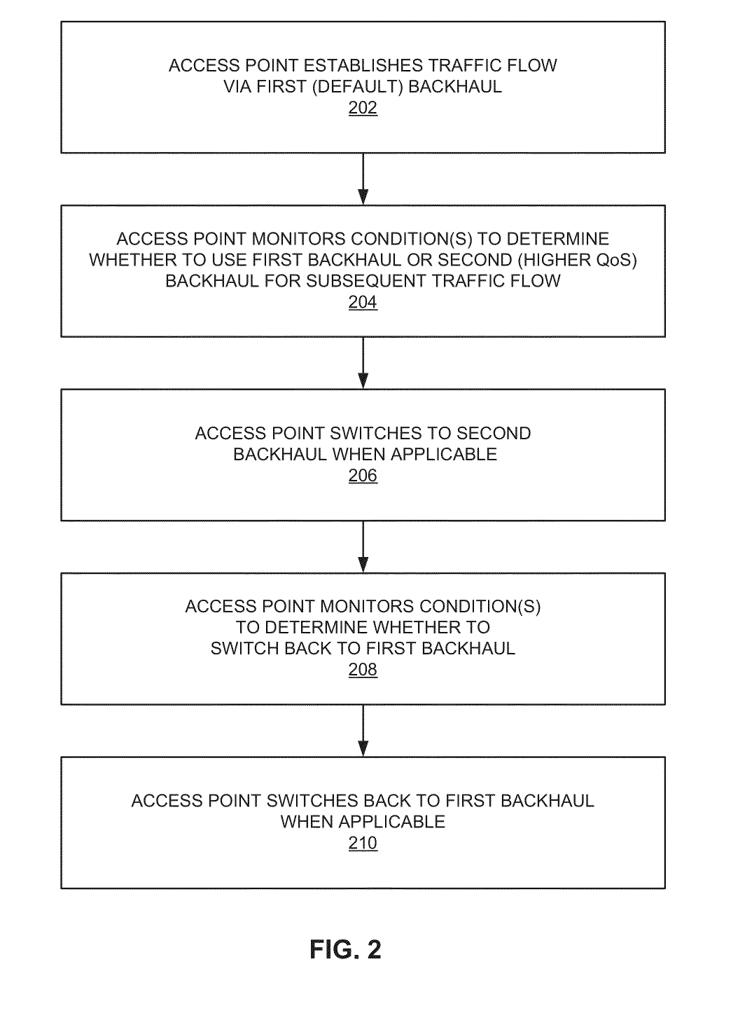

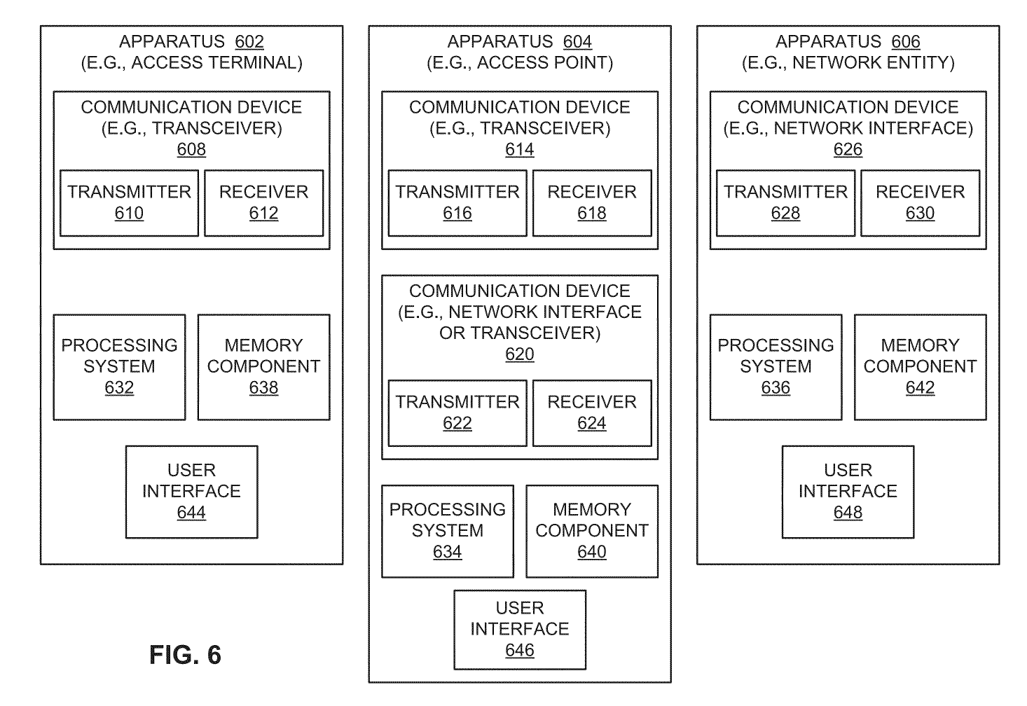

An example of a backhaul selection procedure will be described in conjunction with the flowchart of FIG. 2. For convenience, the operations of FIG. 2 (or any other operations discussed or taught herein) may be described as being performed by specific components (e.g., the components of FIG. 1 or FIG. 6). It should be appreciated, however, that these operations may be performed by other types of components and may be performed using a different number of components. It also should be appreciated that one or more of the operations described herein may not be employed in a given implementation.

As represented by block 202, an access point establishes traffic flow via a first backhaul. As discussed herein, in a typical implementation, the access point is configured to use a particular backhaul by default. For example, a small cell may default to a wired backhaul since such a backhaul may cost less to use than a wireless backhaul. Thus, by default, the access point will route traffic (e.g., send and receive packets) over the wired backhaul.

As represented by block 204, the access point monitors one or more conditions to determine whether to use the first backhaul or a second backhaul for subsequent traffic flow. For example, the access point may monitor traffic flow conditions on one or both of the backhauls to determine which backhaul would better serve the traffic flow.

In a typical implementation, the second backhaul comprises a wireless backhaul. As discussed herein, a wireless backhaul may be capable of providing higher QoS service than the wired backhaul. In some implementations, the wireless backhaul employs wireless wide area network technology.

As represented by block 206, the access point switches to the second backhaul when applicable. For example, upon determining that a particular traffic flow has a high QoS requirement and that the default backhaul cannot (or can no longer) meet this requirement, the access point may switch to the second backhaul. Thus, in this case, the access point may route traffic (e.g., transmit and receive packets) over a wireless backhaul.

As represented by block 208, the access point continues to monitor one or more conditions to determine whether to switch back to the first backhaul. As at block 204, the access point may monitor traffic flow conditions on one or both of the backhauls. In this case, since the access point may no longer be routing traffic over the first backhaul, the access point may monitor conditions in another manner (e.g., monitor other flows, receive information from other entities on the first backhaul, etc.).

As represented by block 210, the access point switches back to the first backhaul when applicable. For example, upon determining that conditions on the first backhaul have improved, the access point may switch back to the first (e.g., cheaper) backhaul.

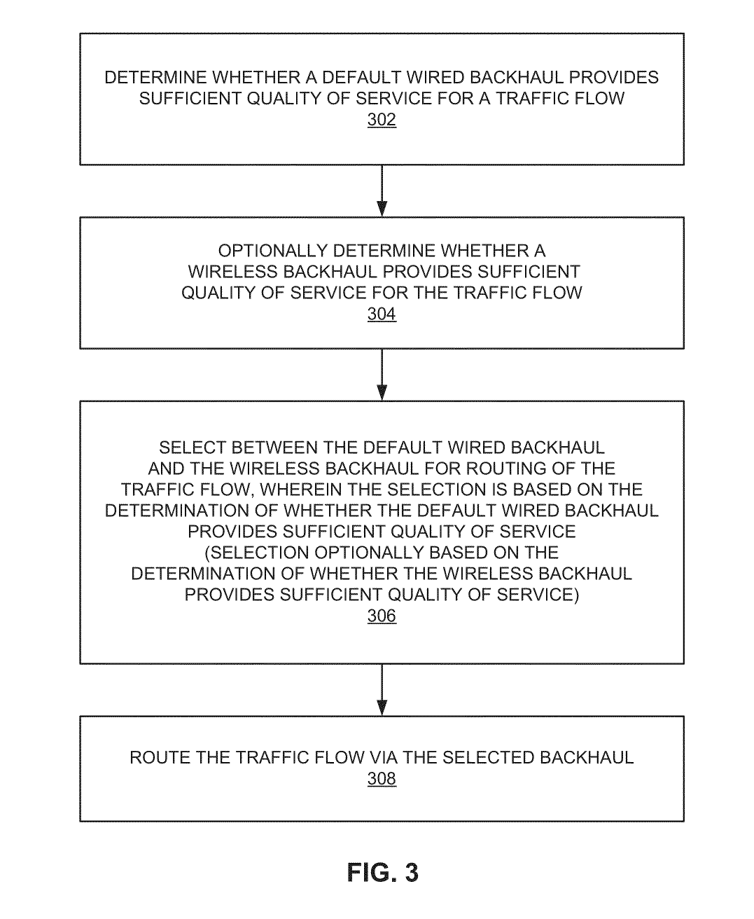

With the above in mind, additional examples of operations that may be performed in accordance with the teachings herein will be described with reference to FIGS. 3-5. In a typical implementation, these operations are performed by an access point. It should be appreciated, however, that some of these operations may be performed by or in conjunction with another entity (e.g., another access point, an access terminal, or a network entity).

FIG. 3 illustrates an example of operations that may be employed in an implementation where a backhaul for routing a traffic flow is selected based on whether a backhaul can support QoS for the traffic flow.

As represented by block 302, a determination is made as to whether a default wired backhaul provides sufficient quality of service for a traffic flow.

In some aspects, the determination of block 302 may involve monitoring traffic queue delays associated with the default wired backhaul. For example, an access point may keep track of the amount of time that certain traffic is in a transmit buffer before being transmitted. In the event the delay exceeds a delay threshold, the default wired backhaul may be deemed as not providing sufficient quality of service for the traffic flow, and vice versa.

In some aspects, the determination of block 302 may involve monitoring traffic round-trip-time associated with the default wired backhaul. For example, an access point may measure the round-trip-time by itself and/or the access point may receive round-trip-time information from at least one other apparatus (e.g., a network entity that cooperates with the access point to conduct a round-trip-time test). In the event the round-trip-time exceeds a round-trip-time threshold, the default wired backhaul may be deemed as not providing sufficient quality of service for the traffic flow, and vice versa.

In some aspects, the determination of block 302 may involve monitoring traffic throughput associated with the default wired backhaul. For example, an access point may measure the throughput by itself and/or the access point may receive throughput information from at least one other apparatus (e.g., a network entity such as a Home NodeB gateway on the backhaul). In the event the throughput falls below a throughput threshold, the default wired backhaul may be deemed as not providing sufficient quality of service for the traffic flow, and vice versa.

In some aspects, the determination of block 302 may involve determining whether the default wired backhaul will provide guaranteed quality of service for the traffic flow. For example; the default wired backhaul may not support guaranteed quality of service, may not be able to guarantee the quality of service required by a particular traffic flow, or may have unpredictable quality of service. In the event quality of service is not guaranteed, the default wired backhaul may be deemed as not providing sufficient quality of service for the traffic flow, and vice versa.

As represented by optional block 304, a determination also may be made as to whether a wireless backhaul provides sufficient quality of service for the traffic flow. This operation may involve determining at least one capability of the wireless backhaul. Such a capability may be determined, for example, by an access point autonomously or by communicating with another access point that provides access to the wireless backhaul.

In some aspects, the determination of block 304 may involve monitoring received signal strength of signals associated with the wireless backhaul. For example, an access point may measure the signal strength by itself and/or the access point may receive signal strength information from at least one other apparatus (e.g., an access point or access terminal operating on the W-WAN). In the event the signal strength falls below a signal strength threshold, the wireless backhaul may be deemed as not providing sufficient quality of service for the traffic flow, and vice versa.

In some aspects, the determination of block 304 may involve monitoring loading associated with the wireless backhaul (e.g., the number of current users and/or traffic volume on the wireless resource over which the backhaul is carried). For example, an access point may measure the loading by itself and/or the access point may receive loading information from at least one other apparatus (e.g., an access point or access terminal operating on the W-WAN). In the event the loading exceeds a loading threshold, the wireless backhaul may be deemed as not providing sufficient quality of service for the traffic flow, and vice versa.

In some aspects, the determination of block 304 may involve determining whether the wireless backhaul will provide guaranteed quality of service for the traffic flow. In the event quality of service is not guaranteed, the wireless backhaul may be deemed as not providing sufficient quality of service for the traffic flow, and vice versa.

As represented by block 306, a selection is made between the default wired backhaul and the wireless backhaul for routing of the traffic flow. Here, the selection between the default wired backhaul and the wireless backhaul is based on the determination of whether the default wired backhaul provides sufficient quality of service for the traffic flow. In scenarios that employ block 304, the selection between the default wired backhaul and the wireless backhaul may also be based on the determination of whether the wireless backhaul provides sufficient quality of service for the traffic flow.

As represented by block 308, the traffic flow is routed via the selected backhaul. For example, non-QoS critical traffic may be routed via a default wired backhaul that does not provide guaranteed QoS, while QoS critical traffic may be routed via a wireless backhaul that does provide guaranteed QoS.

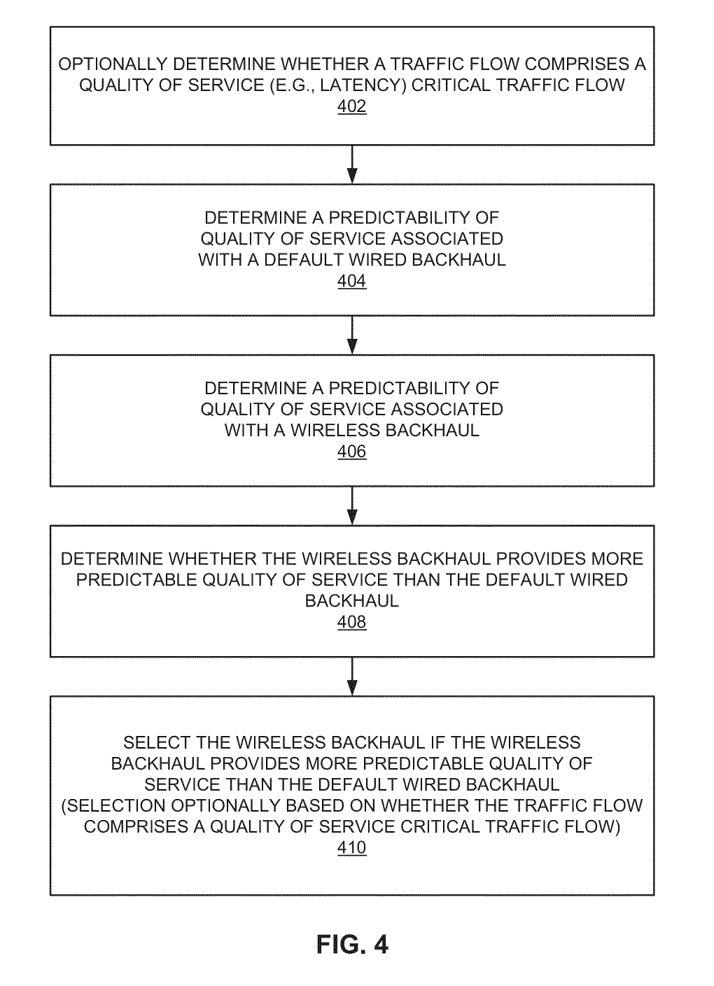

FIG. 4 illustrates an example of operations that may be employed in an implementation where a backhaul is selected based on predictability of quality of service associated with different backhauls.

As represented by optional block 402, a determination may be made as to whether a traffic flow comprises a QoS-critical (e.g., a latency-critical) traffic flow. Such a flow may comprise, for example, voice traffic, video traffic, or signaling traffic (e.g., traffic relating to interference management, handover, load balancing, etc.).

As represented by block 404, a determination is made regarding a predictability of QoS associated with a default wired backhaul. For example, an access point may determine whether the wired backhaul can guarantee a certain latency for a certain period of time.

As represented by block 406, a similar determination is made regarding a predictability of QoS associated with a wireless backhaul. Thus, the access point also may determine whether the wireless backhaul can guarantee a certain latency for a certain period of time.

As represented by block 408, a determination is made, based on the results of blocks 404 and 406, as to whether the wireless backhaul provides more predictable quality of service (e.g., latency) than the default wired backhaul. For example, the access point may determine that the wireless backhaul provides guaranteed QoS while the default wired backhaul does not.

As represented by block 410, the wireless backhaul is selected for routing traffic if the wireless backhaul provides more predictable quality of service than the default wired backhaul. In some implementations, this selection is optionally based on whether the traffic flow comprises a QoS-critical traffic flow. For example, in some cases, the selection of the wireless backhaul may only be done for a QoS-critical traffic flow.

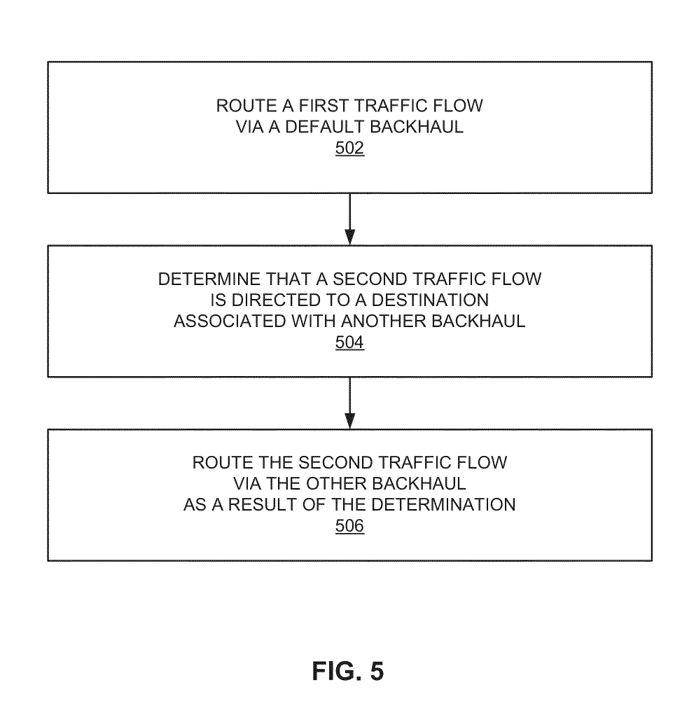

FIG. 5 illustrates an example of operations that may be employed in an implementation where traffic is routed over a backhaul according to a destination of a traffic flow.

As represented by block 502, a first traffic flow is routed via a default backhaul. For example, a femto cell may, by default, route traffic over a wired backhaul.

As represented by block 504, a determination is made that a second traffic flow is directed to (e.g., intended to be consumed by) a destination associated with another backhaul. For example, the traffic flow may be directly destined to the W-WAN associated with the other backhaul (e.g., the traffic may comprise signaling packets between the access point and a W-WAN eNB). Thus, in some aspects, the operations of block 504 may involve determining that the second traffic flow comprises signaling between access points. Also, in some aspects, the operations of block 504 may involve determining that the second traffic flow comprises X2 signaling packets.

As represented by block 506, the second traffic flow is routed via the other backhaul as a result of the determination that the second traffic flow is directed to the destination associated with the other backhaul. For example, a femto cell that accesses a W-WAN backhaul via a macro cell (e.g., an eNB) may send signaling packets to the macro cell via the W-WAN backhaul.

FIG. 6 illustrates several sample components (represented by corresponding blocks) that may be incorporated into an apparatus 602, an apparatus 604, and an apparatus 606 (e.g., corresponding to an access terminal, an access point, and a network entity, respectively) to perform backhaul selection-related operations as taught herein. It should be appreciated that these components may be implemented in different types of apparatuses in different implementations (e.g., in an ASIC, in a system on a chip (SoC), etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 602 and the apparatus 604 each include at least one wireless communication device (represented by the communication devices 608 and 614 (and the communication device 620 if the apparatus 604 is a relay)) for communicating with other nodes via at least one designated radio access technology. Each communication device 608 includes at least one transmitter (represented by the transmitter 610) for transmitting and encoding signals (e.g., messages, indications, information, and so on) and at least one receiver (represented by the receiver 612) for receiving and decoding signals (e.g., messages, indications, information, pilots, and so on). Similarly, each communication device 614 includes at least one transmitter (represented by the transmitter 616) for transmitting signals (e.g., messages, indications, information, pilots, and so on) and at least one receiver (represented by the receiver 618) for receiving signals (e.g., messages, indications, information, and so on). If the apparatus 604 is a relay access point, each communication device 620 may include at least one transmitter (represented by the transmitter 622) for transmitting signals (e.g., messages, indications, information, pilots, and so on) and at least one receiver (represented by the receiver 624) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 604 comprises a network listen module.

The apparatus 606 (and the apparatus 604 if it is not a relay access point) includes at least one communication device (represented by the communication device 626 and, optionally, 620) for communicating with other nodes. For example, the communication device 626 may comprise a network interface that is configured to communicate with one or more network entities via a wire-based or wireless backhaul. In some aspects, the communication device 626 may be implemented as a transceiver configured to support wire-based or wireless signal communication. This communication may involve, for example, sending and receiving: messages, parameters, or other types of information. Accordingly, in the example of FIG. 6, the communication device 626 is shown as comprising a transmitter 628 and a receiver 630. Similarly, if the apparatus 604 is not a relay access point, the communication device 620 may comprise a network interface that is configured to communicate with one or more network entities via a wire-based or wireless backhaul. As with the communication device 626, the communication device 620 is shown as comprising a transmitter 622 and a receiver 624.

The apparatuses 602, 604, and 606 also include other components that may be used in conjunction with backhaul selection-related operations as taught herein. The apparatus 602 includes a processing system 632 for providing functionality relating to, for example, communicating with the apparatus 604 and for providing other processing functionality. The apparatus 604 includes a processing system 634 for providing functionality relating to, for example, selecting a backhaul as taught herein and for providing other processing functionality. The apparatus 606 includes a processing system 636 for providing functionality relating to, for example, supporting backhaul selection as taught herein and for providing other processing functionality. The apparatuses 602, 604, and 606 include memory devices 638, 640, and 642 (e.g., each including a memory device), respectively, for maintaining information (e.g., thresholds, parameters, mapping information, and so on). In addition, the apparatuses 602, 604, and 606 include user interface devices 644, 646, and 648, respectively, for providing indications (e.g., audible and/or visual indications) to a user and/or for receiving user input (e.g., upon user actuation of a sensing device such a keypad, a touch screen, a microphone, and so on).

For convenience, the apparatus 602 is shown in FIG. 6 as including components that may be used in the various examples described herein. In practice, the illustrated blocks may have different functionality in different aspects. For example, functionality of the block 634 for supporting the implementation of FIG. 3 may be different as compared to functionality of the block 634 for supporting the implementation of FIG. 5.

The components of FIG. 6 may be implemented in various ways. In some implementations, the components of FIG. 6 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 608, 632, 638, and 644 may be implemented by processor and memory component(s) of the apparatus 602 (e.g., by execution of appropriate code and/or by appropriate configuration of processor components). Similarly, some or all of the functionality represented by blocks 614, 620, 634, 640, and 646 may be implemented by processor and memory component(s) of the apparatus 604 (e.g., by execution of appropriate code and/or by appropriate configuration of processor components). Also, some or all of the functionality represented by blocks 626, 636, 642, and 648 may be implemented by processor and memory component(s) of the apparatus 606 (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a small cell. It should be appreciated that the teachings herein may be applicable to nodes associated with other types of coverage areas. For example, a pico access point may provide coverage (e.g., coverage within a commercial building) over an area that is smaller than a macro area and larger than a femto cell area. In various applications, other terminology may be used to reference a macro access point, a small cell, or other access point-type nodes. For example, a macro access point may be configured or referred to as an access node, base station, access point, eNodeB, macro cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

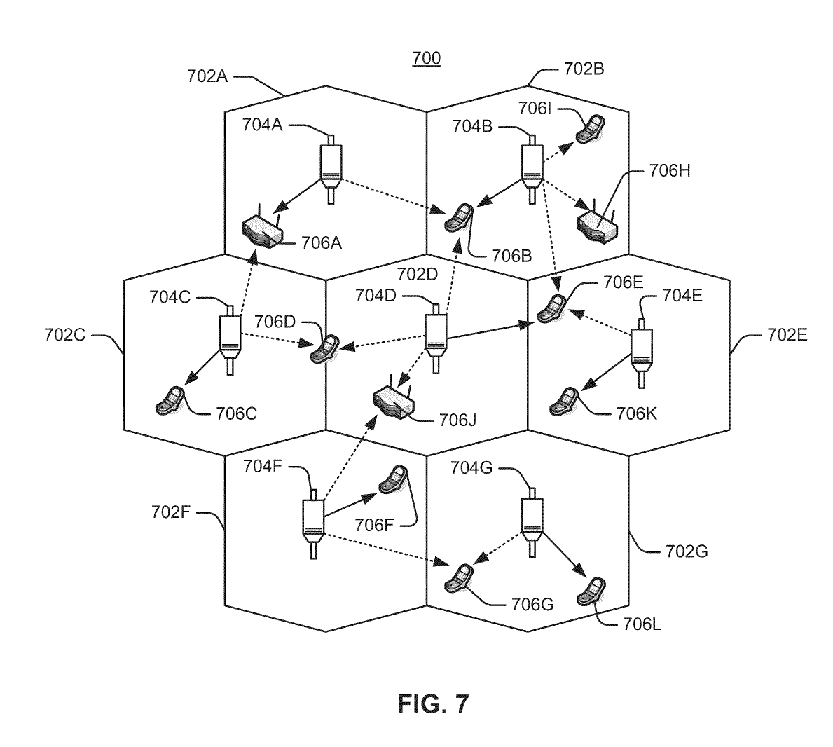

FIG. 7 illustrates a wireless communication system 700, configured to support a number of users, in which the teachings herein may be implemented. The system 700 provides communication for multiple cells 702, such as, for example, macro cells 702A-702G, with each cell being serviced by a corresponding access point 704 (e.g., access points 704A-704G). As shown in FIG. 7, access terminals 706 (e.g., access terminals 706A-706L) may be dispersed at various locations throughout the system over time. Each access terminal 706 may communicate with one or more access points 704 on a forward link (FL) and/or a reverse link (RL) at a given moment, depending upon whether the access terminal 706 is active and whether it is in soft handoff, for example. The wireless communication system 700 may provide service over a large geographic region. For example, macro cells 702A-702G may cover a few blocks in a neighborhood or several miles in a rural environment.

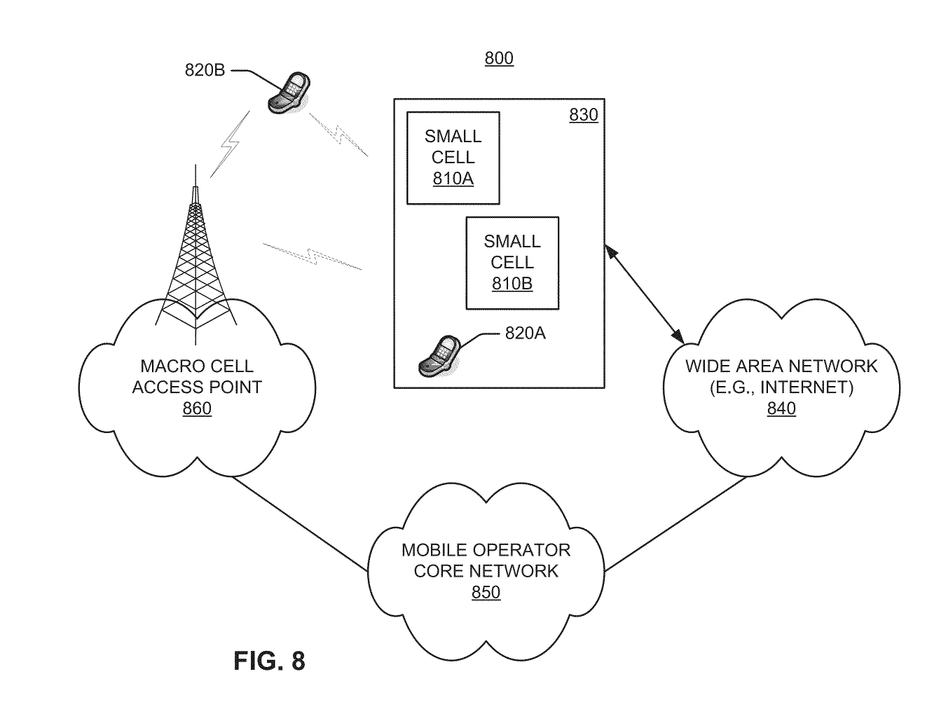

FIG. 8 illustrates an exemplary communication system 800 where one or more small cells are deployed within a network environment. Specifically, the system 800 includes multiple small cells 810 (e.g., small cells 810A and 810B) installed in a relatively small scale network environment (e.g., in one or more user residences 830). Each small cell 810 may be coupled to a wide area network 840 (e.g., the Internet) and a mobile operator core network 850 via a DSL router, a cable modem, a wireless link, or other connectivity means (not shown). As will be discussed below, each small cell 810 may be configured to serve associated access terminals 820 (e.g., access terminal 820A) and, optionally, other (e.g., hybrid or alien) access terminals 820 (e.g., access terminal 820B). In other words, access to small cells 810 may be restricted whereby a given access terminal 820 may be served by a set of designated (e.g., home) small cell(s) 810 but may not be served by any non-designated small cells 810 (e.g., a neighbor's small cell 810).

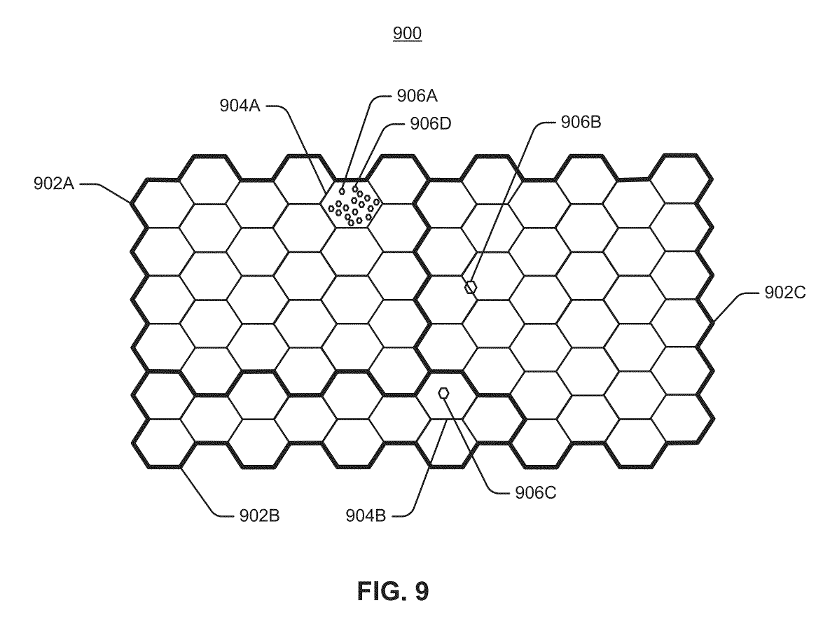

FIG. 9 illustrates an example of a coverage map 900 where several tracking areas 902 (or routing areas or location areas) are defined, each of which includes several macro coverage areas 904. Here, areas of coverage associated with tracking areas 902A, 902B, and 902C are delineated by the wide lines and the macro coverage areas 904 are represented by the larger hexagons. The tracking areas 902 also include femto coverage areas 906. In this example, each of the femto coverage areas 906 (e.g., femto coverage areas 906B and 906C) is depicted within one or more macro coverage areas 904 (e.g., macro coverage areas 904A and 904B). It should be appreciated, however, that some or all of a femto coverage area 906 might not lie within a macro coverage area 904. In practice, a large number of femto coverage areas 906 (e.g., femto coverage areas 906A and 906D) may be defined within a given tracking area 902 or macro coverage area 904. Also, one or more pico coverage areas (not shown) may be defined within a given tracking area 902 or macro coverage area 904.

Referring again to FIG. 8, the owner of a small cell 810 may subscribe to mobile service, such as, for example, 3G mobile service, offered through the mobile operator core network 850. In addition, an access terminal 820 may be capable of operating both in macro environments and in smaller scale (e.g., residential) network environments. In other words, depending on the current location of the access terminal 820, the access terminal 820 may be served by a macro cell access point 860 associated with the mobile operator core network 850 or by any one of a set of small cells 810 (e.g., the small cells 810A and 810B that reside within a corresponding user residence 830). For example, when a subscriber is outside his home, he is served by a standard macro access point (e.g., access point 860) and when the subscriber is at home, he is served by a small cell (e.g., small cell 810A). Here, a small cell 810 may be backward compatible with legacy access terminals 820.

A small cell 810 may be deployed on a single frequency or, in the alternative, on multiple frequencies. Depending on the particular configuration, the single frequency or one or more of the multiple frequencies may overlap with one or more frequencies used by a macro access point (e.g., access point 860).

In some aspects, an access terminal 820 may be configured to connect to a preferred small cell (e.g., the home small cell of the access terminal 820) whenever such connectivity is possible. For example, whenever the access terminal 820A is within the user's residence 830, it may be desired that the access terminal 820A communicate only with the home small cell 810A or 810B.

In some aspects, if the access terminal 820 operates within the macro cellular network 850 but is not residing on its most preferred network (e.g., as defined in a preferred roaming list), the access terminal 820 may continue to search for the most preferred network (e.g., the preferred small cell 810) using a better system reselection (BSR) procedure, which may involve a periodic scanning of available systems to determine whether better systems are currently available and subsequently acquire such preferred systems. The access terminal 820 may limit the search for specific band and channel. For example, one or more femto channels may be defined whereby all small cells (or all restricted small cells) in a region operate on the femto channel(s). The search for the most preferred system may be repeated periodically. Upon discovery of a preferred small cell 810, the access terminal 820 selects the small cell 810 and registers on it for use when within its coverage area.

Access to a small cell may be restricted in some aspects. For example, a given small cell may only provide certain services to certain access terminals. In deployments with so-called restricted (or closed) access, a given access terminal may only be served by the macro cell mobile network and a defined set of small cells (e.g., the small cells 810 that reside within the corresponding user residence 830). In some implementations, an access point may be restricted to not provide, for at least one node (e.g., access terminal), at least one of: signaling, data access, registration, paging, or service.

In some aspects, a restricted small cell (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., small cells) that share a common access control list of access terminals.

Various relationships may thus exist between a given small cell and a given access terminal. For example, from the perspective of an access terminal, an open small cell may refer to a small cell with unrestricted access (e.g., the small cell allows access to any access terminal). A restricted small cell may refer to a small cell that is restricted in some manner (e.g., restricted for access and/or registration). A home small cell may refer to a small cell on which the access terminal is authorized to access and operate on (e.g., permanent access is provided for a defined set of one or more access terminals). A hybrid (or guest) small cell may refer to a small cell on which different access terminals are provided different levels of service (e.g., some access terminals may be allowed partial and/or temporary access while other access terminals may be allowed full access). An alien small cell may refer to a small cell on which the access terminal is not authorized to access or operate on, except for perhaps emergency situations (e.g., 911 calls).

From a restricted small cell perspective, a home access terminal may refer to an access terminal that is authorized to access the restricted small cell installed in the residence of that access terminal's owner (usually the home access terminal has permanent access to that small cell). A guest access terminal may refer to an access terminal with temporary access to the restricted small cell (e.g., limited based on deadline, time of use, bytes, connection count, or some other criterion or criteria). An alien access terminal may refer to an access terminal that does not have permission to access the restricted small cell, except for perhaps emergency situations, for example, such as 911 calls (e.g., an access terminal that does not have the credentials or permission to register with the restricted small cell).

For convenience, the disclosure herein describes various functionality in the context of a small cell. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}<min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

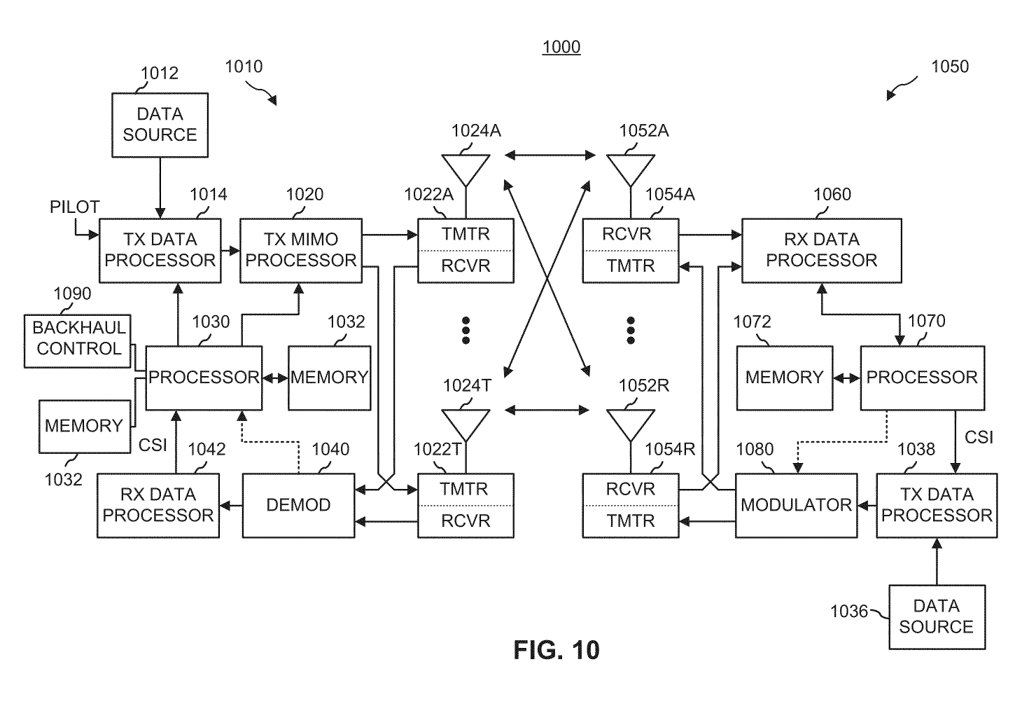

FIG. 10 illustrates a wireless device 1010 (e.g., an access point) and a wireless device 1050 (e.g., an access terminal) of a sample MIMO system 1000. At the device 1010, traffic data for a number of data streams is provided from a data source 1012 to a transmit (TX) data processor 1014. Each data stream may then be transmitted over a respective transmit antenna.

The TX data processor 1014 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1030. A data memory 1032 may store program code, data, and other information used by the processor 1030 or other components of the device 1010.

The modulation symbols for all data streams are then provided to a TX MIMO processor 1020, which may further process the modulation symbols (e.g., for OFDM). The TX MIMO processor 1020 then provides N_{T} modulation symbol streams to N_{T} transceivers (XCVR) 1022A through 1022T. In some aspects, the TX MIMO processor 1020 applies beam-forming weights to the symbols of the data streams and to the antenna from which the symbol is being transmitted.

Each transceiver 1022 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1022A through 1022T are then transmitted from N_{T} antennas 1024A through 1024T, respectively.

At the device 1050, the transmitted modulated signals are received by N_{R} antennas 1052A through 1052R and the received signal from each antenna 1052 is provided to a respective transceiver (XCVR) 1054A through 1054R. Each transceiver 1054 conditions (e.g., filters, amplifies, and downconverts) a respective received signal, digitizes the conditioned signal to provide samples, and further processes the samples to provide a corresponding “received” symbol stream.

A receive (RX) data processor 1060 then receives and processes the N_{R} received symbol streams from N_{R} transceivers 1054 based on a particular receiver processing technique to provide N_{T} “detected” symbol streams. The RX data processor 1060 then demodulates, deinterleaves, and decodes each detected symbol stream to recover the traffic data for the data stream. The processing by the RX data processor 1060 is complementary to that performed by the TX MIMO processor 1020 and the TX data processor 1014 at the device 1010.

A processor 1070 periodically determines which pre-coding matrix to use (discussed below). The processor 1070 formulates a reverse link message comprising a matrix index portion and a rank value portion. A data memory 1072 may store program code, data, and other information used by the processor 1070 or other components of the device 1050.

The reverse link message may comprise various types of information regarding the communication link and/or the received data stream. The reverse link message is then processed by a TX data processor 1038, which also receives traffic data for a number of data streams from a data source 1036, modulated by a modulator 1080, conditioned by the transceivers 1054A through 1054R, and transmitted back to the device 1010.

At the device 1010, the modulated signals from the device 1050 are received by the antennas 1024, conditioned by the transceivers 1022, demodulated by a demodulator (DEMOD) 1040, and processed by a RX data processor 1042 to extract the reverse link message transmitted by the device 1050. The processor 1030 then determines which pre-coding matrix to use for determining the beam-forming weights then processes the extracted message.

FIG. 10 also illustrates that the communication components may include one or more components that perform backhaul selection-related control operations as taught herein. For example, a backhaul control component 1090 may cooperate with the processor 1030 and/or other components of the device 1010 to select a backhaul as taught herein. It should be appreciated that for each device 1010 and 1050 the functionality of two or more of the described components may be provided by a single component. For example, a single processing component may provide the functionality of the backhaul control component 1090 and the processor 1030.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

In view of the above, in some aspects a first apparatus for communication comprises: a communication device configured to route a first traffic flow via a default backhaul; and a processing system configured to determine that a second traffic flow is directed to a destination associated with another backhaul, wherein the communication device is further configured to route the second traffic flow via the other backhaul as a result of the determination that the second traffic flow is directed to the destination associated with the other backhaul.

In addition, in some aspects at least one of the following also may apply to the first apparatus for communication: the determination that the second traffic flow is directed to a destination associated with the other backhaul comprises determining that the second traffic flow is directed to an access point that provides access to the other backhaul; the determination that the second traffic flow is directed to a destination associated with the other backhaul comprises determining that the second traffic flow comprises signaling between access points; the determination that the second traffic flow is directed to a destination associated with the other backhaul comprises determining that the second traffic flow comprises X2 signaling packets; the default backhaul and the other backhaul employ different communication technology; the default backhaul comprises a wired backhaul, and the other backhaul comprises a wireless backhaul; the other backhaul comprises a wireless wide area network backhaul; the apparatus comprises a femto cell, and the apparatus accesses the other backhaul via a macro cell; or the second traffic flow comprises signaling destined for the macro cell.

In view of the above, in some aspects a first method of communication comprises: routing a first traffic flow via a default backhaul; determining that a second traffic flow is directed to a destination associated with another backhaul; and routing the second traffic flow via the other backhaul as a result of the determination that the second traffic flow is directed to the destination associated with the other backhaul.

In addition, in some aspects at least one of the following also may apply to the first method of communication: the determination that the second traffic flow is directed to a destination associated with the other backhaul comprises determining that the second traffic flow is directed to an access point that provides access to the other backhaul; the determination that the second traffic flow is directed to a destination associated with the other backhaul comprises determining that the second traffic flow comprises signaling between access points; the determination that the second traffic flow is directed to a destination associated with the other backhaul comprises determining that the second traffic flow comprises X2 signaling packets; the default backhaul and the other backhaul employ different communication technology; the default backhaul comprises a wired backhaul, and the other backhaul comprises a wireless backhaul; the other backhaul comprises a wireless wide area network backhaul; the method is performed by a femto cell, and the femto cell accesses the other backhaul via a macro cell; or the second traffic flow comprises signaling destined for the macro cell.

In view of the above, in some aspects a second apparatus for communication comprises: means for routing a first traffic flow via a default backhaul; means for determining that a second traffic flow is directed to a destination associated with another backhaul; and means for routing the second traffic flow via the other backhaul as a result of the determination that the second traffic flow is directed to the destination associated with the other backhaul.

In addition, in some aspects at least one of the following also may apply to the second apparatus for communication: the determination that the second traffic flow is directed to a destination associated with the other backhaul comprises determining that the second traffic flow is directed to an access point that provides access to the other backhaul; the determination that the second traffic flow is directed to a destination associated with the other backhaul comprises determining that the second traffic flow comprises signaling between access points; the determination that the second traffic flow is directed to a destination associated with the other backhaul comprises determining that the second traffic flow comprises X2 signaling packets; the default backhaul and the other backhaul employ different communication technology; the default backhaul comprises a wired backhaul, and the other backhaul comprises a wireless backhaul; the other backhaul comprises a wireless wide area network backhaul; the apparatus comprises a femto cell, and the apparatus accesses the other backhaul via a macro cell; or the second traffic flow comprises signaling destined for the macro cell.

In view of the above, in some aspects a computer-program product comprises: computer-readable medium comprising code for causing a computer to: route a first traffic flow via a default backhaul; determine that a second traffic flow is directed to a destination associated with another backhaul; and route the second traffic flow via the other backhaul as a result of the determination that the second traffic flow is directed to the destination associated with the other backhaul.

In addition, in some aspects at least one of the following also may apply to the computer-program product: the determination that the second traffic flow is directed to a destination associated with the other backhaul comprises determining that the second traffic flow is directed to an access point that provides access to the other backhaul; the determination that the second traffic flow is directed to a destination associated with the other backhaul comprises determining that the second traffic flow comprises signaling between access points; the determination that the second traffic flow is directed to a destination associated with the other backhaul comprises determining that the second traffic flow comprises X2 signaling packets; the default backhaul and the other backhaul employ different communication technology; the default backhaul comprises a wired backhaul, and the other backhaul comprises a wireless backhaul; the other backhaul comprises a wireless wide area network backhaul; the apparatus is embodied in a femto cell, and the femto cell accesses the other backhaul via a macro cell; or the second traffic flow comprises signaling destined for the macro cell.

The functionality described herein (e.g., with regard to one or more of the accompanying figures) may correspond in some aspects to similarly designated “means for” functionality in the appended claims.

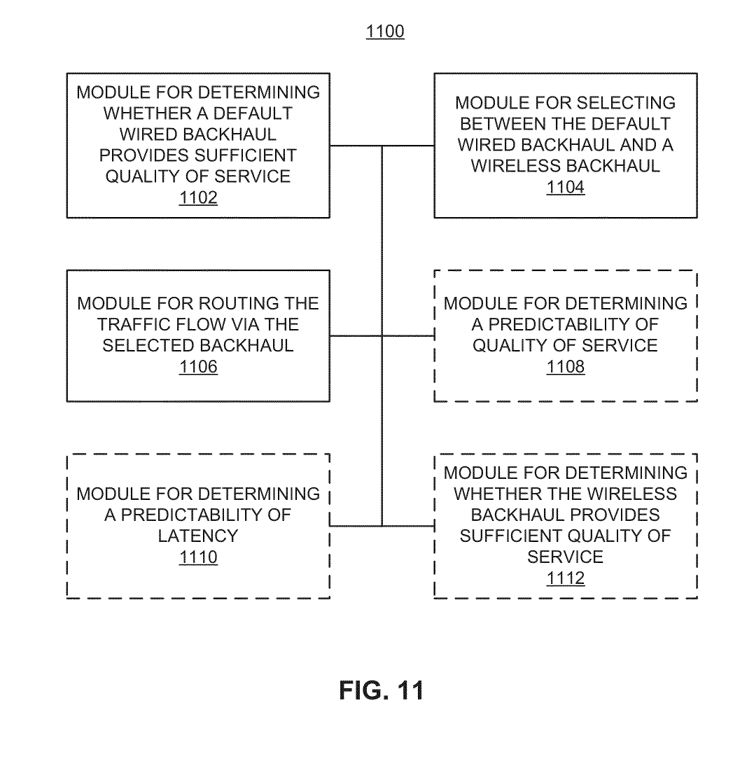

Referring to FIG. 11, an apparatus 1100 is represented as a series of interrelated functional modules. A module for determining whether a default wired backhaul provides sufficient quality of service 1102 may correspond at least in some aspects to, for example, a processing system as discussed herein. A module for selecting between the default wired backhaul and a wireless backhaul 1104 may correspond at least in some aspects to, for example, a processing system as discussed herein. A module for routing the traffic flow via the selected backhaul 1106 may correspond at least in some aspects to, for example, a communication device as discussed herein. A module for determining a predictability of quality of service 1108 may correspond at least in some aspects to, for example, a processing system as discussed herein. A module for determining a predictability of latency 1110 may correspond at least in some aspects to, for example, a processing system as discussed herein. A module for determining whether a wireless backhaul provides sufficient quality of service 1112 may correspond at least in some aspects to, for example, a processing system as discussed herein.

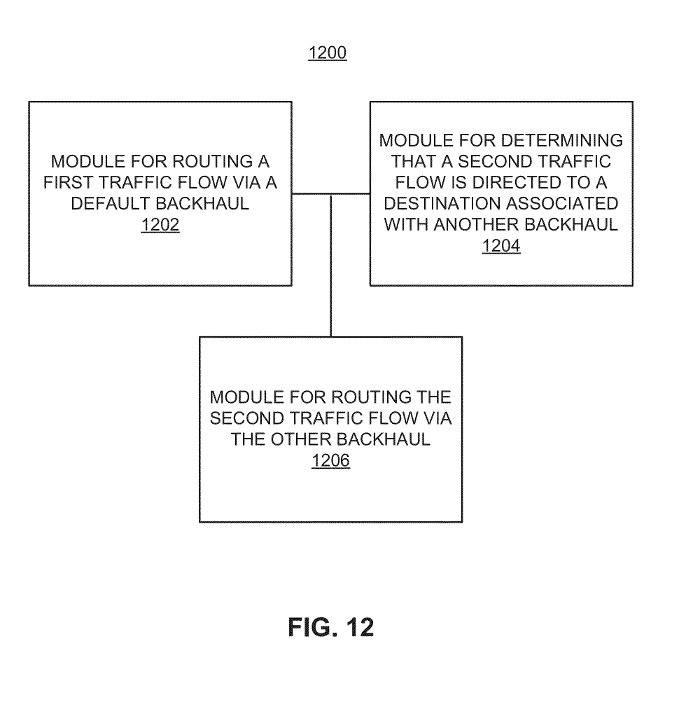

Referring to FIG. 12, an apparatus 1200 is represented as a series of interrelated functional modules. A module for routing a first traffic flow via a default backhaul 1202 may correspond at least in some aspects to, for example, a communication device as discussed herein. A module for determining that a second traffic flow is directed to a destination associated with another backhaul 1204 may correspond at least in some aspects to, for example, a processing system as discussed herein. A module for routing the second traffic flow via the other backhaul 1206 may correspond at least in some aspects to, for example, a communication device as discussed herein.

The functionality of the modules of FIGS. 11 and 12 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. As one specific example, the apparatus 1100 may comprise a single device (e.g., components 1102-1112 comprising different sections of an ASIC). As another specific example, the apparatus 1100 may comprise several devices (e.g., the components 1102, 1104, 1108, 1110, and 1112 comprising one ASIC and the component 1106 comprising another ASIC). The functionality of these modules also may be implemented in some other manner as taught herein. In some aspects one or more of any dashed blocks in FIGS. 11 and 12 are optional.

In addition, the components and functions represented by FIGS. 11 and 12 as well as other components and functions described herein, may be implemented using any suitable means. Such means also may be implemented, at least in part, using corresponding structure as taught herein. For example, the components described above in conjunction with the “module for” components of FIGS. 11 and 12 also may correspond to similarly designated “means for” functionality. Thus, in some aspects one or more of such means may be implemented using one or more of processor components, integrated circuits, or other suitable structure as taught herein. Several examples follow. In some aspects, means for determining comprises a processing system, means for selecting comprises a processing system, and means for routing comprises a communication device.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising code(s) executable (e.g., executable by at least one computer) to provide functionality relating to one or more of the aspects of the disclosure. In some aspects, a computer program product may comprise packaging materials.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage medium, computer-readable storage device, etc.). Such a non-transitory computer-readable medium (e.g., computer-readable storage device) may comprise any of the tangible forms of media described herein or otherwise known (e.g., a memory device, a media disk, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for wireless communication, comprising:
a processing system configured to determine whether a default wired backhaul provides sufficient quality of service for a traffic flow, and further configured to select between the default wired backhaul and a wireless backhaul for routing of the traffic flow, wherein the selection between the default wired backhaul and the wireless backhaul is based on the determination of whether the default wired backhaul provides sufficient quality of service; and
a communication device configured to route the traffic flow via the selected backhaul.

2. The apparatus of claim 1, wherein the determination of whether the default wired backhaul provides sufficient quality of service comprises monitoring traffic queue delays associated with the default wired backhaul.

3. The apparatus of claim 1, wherein the determination of whether the default wired backhaul provides sufficient quality of service comprises monitoring traffic round-trip-time associated with the default wired backhaul.

4. The apparatus of claim 1, wherein the determination of whether the default wired backhaul provides sufficient quality of service comprises monitoring traffic throughput associated with the default wired backhaul.

5. The apparatus of claim 1, wherein the determination of whether the default wired backhaul provides sufficient quality of service comprises determining whether the default wired backhaul will provide guaranteed quality of service for the traffic flow.

6. The apparatus of claim 1, wherein:
the determination of whether the default wired backhaul provides sufficient quality of service comprises determining a first predictability of quality of service associated with the default wired backhaul;
the processing system is further configured to determine a second predictability of quality of service associated with the wireless backhaul; and
the selection between the default wired backhaul and the wireless backhaul comprises determining, based on the first predictability of quality of service and the second predictability of quality of service, whether the wireless backhaul provides more predictable quality of service than the default wired backhaul.

7. The apparatus of claim 1, wherein:
the determination of whether the default wired backhaul provides sufficient quality of service comprises determining whether the traffic flow comprises a latency critical traffic flow and determining a first predictability of latency associated with the default wired backhaul;
the processing system is further configured to determine a second predictability of latency associated with the wireless backhaul; and
if the traffic flow comprises a latency critical traffic flow, the selection between the default wired backhaul and the wireless backhaul comprises determining, based on the first predictability of latency and the second predictability of latency, whether the wireless backhaul provides more predictable latency than the default wired backhaul.

8. The apparatus of claim 1, wherein:
the processing system is further configured to determine whether the wireless backhaul provides sufficient quality of service for the traffic flow; and
the selection between the default wired backhaul and the wireless backhaul is further based on the determination of whether the wireless backhaul provides sufficient quality of service for the traffic flow.

9. The apparatus of claim 8, wherein the determination of whether the wireless backhaul provides sufficient quality of service comprises monitoring received signal strength of signals associated with the wireless backhaul.

10. The apparatus of claim 8, wherein the determination of whether the wireless backhaul provides sufficient quality of service comprises monitoring loading associated with the wireless backhaul.

11. The apparatus of claim 8, wherein the determination of whether the wireless backhaul provides sufficient quality of service comprises determining whether the wireless backhaul will provide guaranteed quality of service for the traffic flow.

12. The apparatus of claim 8, wherein the determination of whether the wireless backhaul provides sufficient quality of service comprises determining at least one capability of the wireless backhaul by communicating with an access point that provides access to the wireless backhaul.

13. The apparatus of claim 1, wherein the wireless backhaul employs wireless wide area network technology.

14. The apparatus of claim 1, wherein:
the apparatus comprises a femto cell; and
the apparatus accesses the wireless backhaul via a macro cell.

15. A method of wireless communication, comprising:
determining whether a default wired backhaul provides sufficient quality of service for a traffic flow;
selecting between the default wired backhaul and a wireless backhaul for routing of the traffic flow, wherein the selection between the default wired backhaul and the wireless backhaul is based on the determination of whether the default wired backhaul provides sufficient quality of service; and
routing the traffic flow via the selected backhaul.

16. The method of claim 15, wherein the determination of whether the default wired backhaul provides sufficient quality of service comprises monitoring traffic queue delays associated with the default wired backhaul.

17. The method of claim 15, wherein the determination of whether the default wired backhaul provides sufficient quality of service comprises monitoring traffic round-trip-time associated with the default wired backhaul.

18. The method of claim 15, wherein the determination of whether the default wired backhaul provides sufficient quality of service comprises monitoring traffic throughput associated with the default wired backhaul.

19. The method of claim 15, wherein the determination of whether the default wired backhaul provides sufficient quality of service comprises determining whether the default wired backhaul will provide guaranteed quality of service for the traffic flow.

20. The method of claim 15, wherein:
the determination of whether the default wired backhaul provides sufficient quality of service comprises determining a first predictability of quality of service associated with the default wired backhaul;
the method further comprises determining a second predictability of quality of service associated with the wireless backhaul; and
the selection between the default wired backhaul and the wireless backhaul comprises determining, based on the first predictability of quality of service and the second predictability of quality of service, whether the wireless backhaul provides more predictable quality of service than the default wired backhaul.

21. The method of claim 15, wherein:
the determination of whether the default wired backhaul provides sufficient quality of service comprises determining whether the traffic flow comprises a latency critical traffic flow and determining a first predictability of latency associated with the default wired backhaul;
the method further comprises determining a second predictability of latency associated with the wireless backhaul; and
if the traffic flow comprises a latency critical traffic flow, the selection between the default wired backhaul and the wireless backhaul comprises determining, based on the first predictability of latency and the second predictability of latency, whether the wireless backhaul provides more predictable latency than the default wired backhaul.

22. The method of claim 15, further comprising determining whether the wireless backhaul provides sufficient quality of service for the traffic flow, wherein the selection between the default wired backhaul and the wireless backhaul is further based on the determination of whether the wireless backhaul provides sufficient quality of service for the traffic flow.

23. The method of claim 22, wherein the determination of whether the wireless backhaul provides sufficient quality of service comprises monitoring received signal strength of signals associated with the wireless backhaul.

24. The method of claim 22, wherein the determination of whether the wireless backhaul provides sufficient quality of service comprises monitoring loading associated with the wireless backhaul.

25. The method of claim 22, wherein the determination of whether the wireless backhaul provides sufficient quality of service comprises determining whether the wireless backhaul will provide guaranteed quality of service for the traffic flow.

26. The method of claim 22, wherein the determination of whether the wireless backhaul provides sufficient quality of service comprises determining at least one capability of the wireless backhaul by communicating with an access point that provides access to the wireless backhaul.

27. The method of claim 15, wherein the wireless backhaul employs wireless wide area network technology.

28. The method of claim 15, wherein:
the method is performed by a femto cell; and
the femto cell accesses the wireless backhaul via a macro cell.

29. An apparatus for wireless communication, comprising:
means for determining whether a default wired backhaul provides sufficient quality of service for a traffic flow;
means for selecting between the default wired backhaul and a wireless backhaul for routing of the traffic flow, wherein the selection between the default wired backhaul and the wireless backhaul is based on the determination of whether the default wired backhaul provides sufficient quality of service; and
means for routing the traffic flow via the selected backhaul.

30. The apparatus of claim 29, wherein the determination of whether the default wired backhaul provides sufficient quality of service comprises monitoring traffic queue delays associated with the default wired backhaul.

31. The apparatus of claim 29, wherein the determination of whether the default wired backhaul provides sufficient quality of service comprises monitoring traffic round-trip-time associated with the default wired backhaul.

32. The apparatus of claim 29, wherein the determination of whether the default wired backhaul provides sufficient quality of service comprises monitoring traffic throughput associated with the default wired backhaul.

33. The apparatus of claim 29, wherein:
the determination of whether the default wired backhaul provides sufficient quality of service comprises determining a first predictability of quality of service associated with the default wired backhaul;
the apparatus further comprises means for determining a second predictability of quality of service associated with the wireless backhaul; and
the selection between the default wired backhaul and the wireless backhaul comprises determining, based on the first predictability of quality of service and the second predictability of quality of service, whether the wireless backhaul provides more predictable quality of service than the default wired backhaul.

34. The apparatus of claim 29, wherein:
the determination of whether the default wired backhaul provides sufficient quality of service comprises determining whether the traffic flow comprises a latency critical traffic flow and determining a first predictability of latency associated with the default wired backhaul;
the apparatus further comprises means for determining a second predictability of latency associated with the wireless backhaul; and
if the traffic flow comprises a latency critical traffic flow, the selection between the default wired backhaul and the wireless backhaul comprises determining, based on the first predictability of latency and the second predictability of latency, whether the wireless backhaul provides more predictable latency than the default wired backhaul.

35. The apparatus of claim 29, further comprising means for determining whether the wireless backhaul provides sufficient quality of service for the traffic flow, wherein the selection between the default wired backhaul and the wireless backhaul is further based on the determination of whether the wireless backhaul provides sufficient quality of service for the traffic flow.

36. The apparatus of claim 35, wherein the determination of whether the wireless backhaul provides sufficient quality of service comprises monitoring received signal strength of signals associated with the wireless backhaul.

37. The apparatus of claim 35, wherein the determination of whether the wireless backhaul provides sufficient quality of service comprises monitoring loading associated with the wireless backhaul.

38. A computer-program product, comprising:
computer-readable medium comprising code for causing a computer to:
determine whether a default wired backhaul provides sufficient quality of service for a traffic flow;
select between the default wired backhaul and a wireless backhaul for routing of the traffic flow, wherein the selection between the default wired backhaul and the wireless backhaul is based on the determination of whether the default wired backhaul provides sufficient quality of service; and
route the traffic flow via the selected backhaul.

39. The computer-program product of claim 38, wherein the determination of whether the default wired backhaul provides sufficient quality of service comprises monitoring traffic queue delays associated with the default wired backhaul.

40. The computer-program product of claim 38, wherein the determination of whether the default wired backhaul provides sufficient quality of service comprises monitoring traffic round-trip-time associated with the default wired backhaul.

41. The computer-program product of claim 38, wherein the determination of whether the default wired backhaul provides sufficient quality of service comprises monitoring traffic throughput associated with the default wired backhaul.

42. The computer-program product of claim 38, wherein the determination of whether the default wired backhaul provides sufficient quality of service comprises determining whether the default wired backhaul will provide guaranteed quality of service for the traffic flow.

43. The computer-program product of claim 38, wherein:
the determination of whether the default wired backhaul provides sufficient quality of service comprises determining a first predictability of quality of service associated with the default wired backhaul;
the computer-readable medium further comprises code for causing the computer to determine a second predictability of quality of service associated with the wireless backhaul; and
the selection between the default wired backhaul and the wireless backhaul comprises determining, based on the first predictability of quality of service and the second predictability of quality of service, whether the wireless backhaul provides more predictable quality of service than the default wired backhaul.

44. The computer-program product of claim 38, wherein:
the determination of whether the default wired backhaul provides sufficient quality of service comprises determining whether the traffic flow comprises a latency critical traffic flow and determining a first predictability of latency associated with the default wired backhaul;
the computer-readable medium further comprises code for causing the computer to determine a second predictability of latency associated with the wireless backhaul; and
if the traffic flow comprises a latency critical traffic flow, the selection between the default wired backhaul and the wireless backhaul comprises determining, based on the first predictability of latency and the second predictability of latency, whether the wireless backhaul provides more predictable latency than the default wired backhaul.

45. The computer-program product of claim 38, wherein;
the computer-readable medium further comprises code for causing the computer to determine whether the wireless backhaul provides sufficient quality of service for the traffic flow; and
the selection between the default wired backhaul and the wireless backhaul is further based on the determination of whether the wireless backhaul provides sufficient quality of service for the traffic flow.

46. The computer-program product of claim 45, wherein the determination of whether the wireless backhaul provides sufficient quality of service comprises monitoring received signal strength of signals associated with the wireless backhaul.

47. The computer-program product of claim 45, wherein the determination of whether the wireless backhaul provides sufficient quality of service comprises monitoring loading associated with the wireless backhaul.

48. An apparatus for wireless communication, comprising:
a communication device configured to route a first traffic flow via a default backhaul; and
a processing system configured to determine that a second traffic flow is directed to a destination associated with another backhaul,
wherein the communication device is further configured to route the second traffic flow via the other backhaul as a result of the determination that the second traffic flow is directed to the destination associated with the other backhaul.

49. A method of wireless communication, comprising:
routing a first traffic flow via a default backhaul;
determining that a second traffic flow is directed to a destination associated with another backhaul; and
routing the second traffic flow via the other backhaul as a result of the determination that the second traffic flow is directed to the destination associated with the other backhaul.

50. An apparatus for wireless communication, comprising:
means for routing a first traffic flow via a default backhaul;
means for determining that a second traffic flow is directed to a destination associated with another backhaul; and
means for routing the second traffic flow via the other backhaul as a result of the determination that the second traffic flow is directed to the destination associated with the other backhaul.

51. A computer-program product, comprising:
computer-readable medium comprising code for causing a computer to:
route a first traffic flow via a default backhaul;
determine that a second traffic flow is directed to a destination associated with another backhaul; and
route the second traffic flow via the other backhaul as a result of the determination that the second traffic flow is directed to the destination associated with the other backhaul.
